(19) United States
(12) Patent Application Publication
(10) Pub. No.: US 2008/0171145 A1
(43) Pub. Date: Jul. 17, 2008

(54) TWO-TONE PAINTING METHOD

(75) Inventors: Cynthia A. Stants, Pinckney, MI (US); Thomas C. Balch, West Bloomfield, MI (US)

Correspondence Address: BASF CORPORATION;Patent Department, 1609 BIDDLE AVENUE, MAIN BUILDING, WYANDOTTE, MI, 48192, US

(73) Assignee: BASF CORPORATION, SOUTHFIELD, MI (US)

(21) Appl. No.: 11/623,186

(22) Filed: Jan. 15, 2007

(51) Int. Cl. B05D 3/02

(52) U.S. Cl. 427/189

(57) ABSTRACT

A two-tone painting method includes applying a powder primer to a substrate, followed by a powder basecoat applied dry-on-dry onto the powder primer. The powder basecoat is preferably applied in the same painting booth as the powder primer, i.e., without curing the powder primer. The powder basecoat includes a flake additive, such as a mica flake or a metal flake, which prevents surface irregularities from forming in the powder primer and the powder basecoat as a result of not curing the powder primer before applying the powder basecoat. The substrate is then masked, and a second basecoat is applied. The masking is then removed and a clearcoat is applied. The second basecoat and the clearcoat are then cured simultaneously in an oven.

### BACKGROUND OF THE INVENTION

1. Field of the Invention

The subject invention generally relates to a method of painting a substrate.

2. Description of the Related Art

Current two-tone painting methods typically include cleaning the substrate with an iron phosphate wash, followed by applying and curing an electrocoat to the substrate. The substrate is moved to a first paint booth, where a primer (either a powder primer or a liquid primer) is applied onto the electrocoat. The substrate is then moved to a first oven, where the substrate is baked to cure the primer. After the primer is cured, the substrate is moved to a second paint booth, where a first basecoat (first color coat), or optionally a first basecoat and a clearcoat, is applied. The substrate is then moved to a second oven, where the substrate is baked to cure the first color coat. Once the first color coat is cured, the substrate is masked to define a first portion and a second portion with the mask covering one of the first and second portions. After the substrate is masked, the substrate is moved to a third paint booth, where a second basecoat (second color coat), or optionally a second basecoat and a clearcoat, is applied onto the one of the first portion or the second portion that is not covered by the mask. In other words, if the first portion is masked off, the second color coat is applied to the second portion, whereas if the second portion is masked off, the second color coat is applied to the first portion of the substrate. Accordingly, upon completion of the two-tone painting method, the first portion will have a different color than the second portion. If no clearcoat is applied to either portion in the previous steps, once the second color coat is applied, the mask is removed, and a clearcoat is applied over both the first portion and the second portion of the substrate, onto the first basecoat and the second basecoat respectively. After the clearcoat is applied, the substrate is moved to a third oven, where the substrate is baked to cure the second color coat and the clearcoat simultaneously.

Moving the substrate between the various paint booths and ovens requires a significant amount of time. Additionally, the curing of the different compositions (the primer, the first basecoat, the second basecoat, and the clearcoat) in the various ovens consumes significant space along a production line, as well as requiring a large amount of energy to heat the ovens, thereby adding to the cost of painting the substrate.

Various attempts have been made to combine and/or eliminate the curing steps. These abbreviated methods are often referred to as compact painting methods. Such an example would be to eliminate the step of curing the primer, i.e., applying the first basecoat onto the primer without curing the primer. However, it has been found that eliminating the step of curing the primer creates craters in the primer that transfer through to a finished painted surface, providing an unsatisfactory paint appearance. Therefore, there still remains a need to provide a compact two-tone painting method while maintaining a high quality paint appearance.

### SUMMARY OF THE INVENTION AND ADVANTAGES

The subject invention provides a method of painting a substrate with a powder primer, a powder basecoat, and a topcoat. The method comprises the steps of applying the powder primer onto the substrate to form a powder primer layer, and then applying the powder basecoat, comprising a flake additive, onto the powder primer to form a powder basecoat layer. The method further comprises the steps of simultaneously curing the powder primer and the powder basecoat, wherein the flake additive prevents surface irregularities in the powder primer layer and the powder basecoat layer, applying the topcoat onto the powder basecoat, and curing the topcoat by application of heat.

Accordingly, the two-tone painting method eliminates the step of curing the primer in an oven by utilizing a powder primer in combination with a powder basecoat containing a flake additive. The flake additive prevents surface irregularities from forming in the powder primer layer and the powder basecoat layer. These surface irregularities tend to form because the powder primer is not cured prior to application of the powder basecoat. The powder basecoat may be applied in the same paint booth as the powder primer. Therefore, the two-tone painting process of the subject invention reduces the amount of space required in the production line by eliminating one of the required ovens and optionally eliminates one of the paint booths, reduces the cost of painting the substrate by eliminating the energy requirements to heat the one eliminated oven, and also speeds the production rate by eliminating movement between the painting booth and the one eliminated oven, while still providing a high quality paint appearance in which the surface irregularities defined by the powder primer layer are not transferred through the painting process to the finished product.

### BRIEF DESCRIPTION OF THE DRAWINGS

Other advantages of the present invention will be readily appreciated, as the same becomes better understood by reference to the following detailed description when considered in connection with the accompanying drawing wherein:

FIG. 1 is a flowchart generally illustrating the two-tone painting method of the present invention.

### DETAILED DESCRIPTION OF THE INVENTION

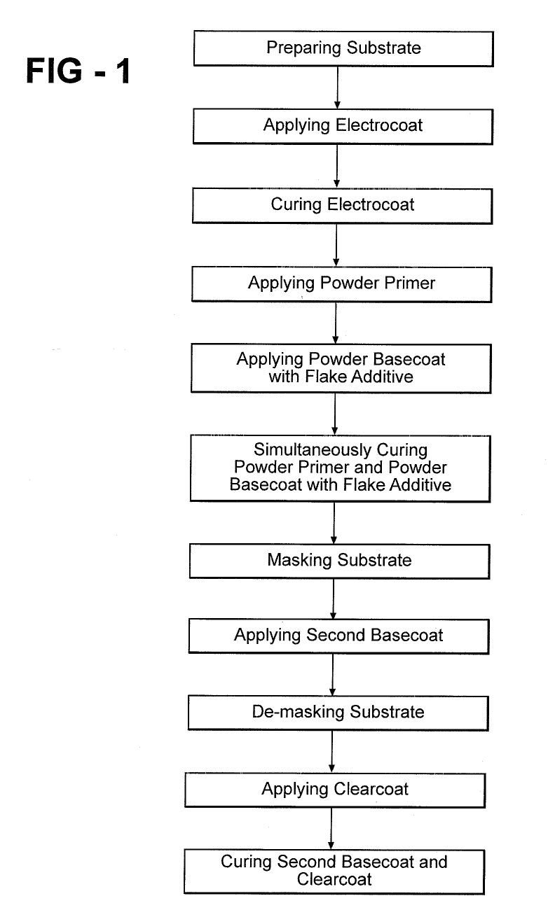

Referring to FIG. 1, a method of painting a substrate is generally shown. The method includes applying a powder primer, a powder basecoat, and a topcoat to the substrate.

Although not required, the powder primer is preferably a low density powder primer. Therefore, it should be understood that either a standard powder primer or a low density powder primer may be utilized in accordance with the subject invention. The powder primer includes a pigment content and a binder content. These contents may be characterized by a pigment to binder ratio as is well known in the art. The pigment content has a higher weight per unit volume relative to the binder content. Accordingly, when the pigment content is lowered relative to the binder content, the overall weight of the powder primer decreases per unit volume. Therefore, a low density powder primer includes a higher binder content relative to the pigment content than is commonly utilized in a standard powder primer. Typically, a low density powder primer includes a density of less than 1.4 g/cm³, with a standard or high density powder primer including a density of greater than 1.4 g/cm³. Examples of suitable powder primers are disclosed in United States Patent Publication 2004/0236037 A1, Ser. No. 10/440,974, published on Nov. 25, 2004, and U.S. Pat. No. 5,508,349, Ser. No., 08/239,670, published on Apr. 16, 1996, the disclosures of both of which are herein incorporated by reference in their entirety. One typical powder primer is commonly referred to as a hybrid powder primer due to its chemical backbone being based on polyester and epoxy.

The powder basecoat is preferably a urethane powder basecoat, and includes a flake additive. Preferably, the flake additive comprises at least one of a mica flake and a metal flake. It should be understood that the subject invention may utilize the mica flake additive alone, the metal flake additive alone, or a combination of the mica flake additive and the metal flake additive. Examples of commercially available flake additives include Powdal 2600™ and Powdal 2900™ produced by Schlenk; PCR212™, PCR 214™, and PCS1000™ produced by Eckart, PCF 8160™ produced by Toyal, and 7642 SI™ and 7624 SI™ produced by Benda-Lutz. Examples of commercially available mica flake additives include Iriodin 97225SW™ and Iriodi 9205SW™ produced by EMD Chemicals, Mearlin Bright Silver 1303Z™ and Mearlin Micro Copper™ produced by Englhard, and Afflair 9111™, Afflair 9119™, and Afflair 9323™ produced by EM Industries. It should be understood that the flake additive may include some other product not specifically enumerated or described herein and still fall within the scope of the claims. The powder basecoat preferably comprises at least 0.1 parts by weight of the flake additive per 100 parts by weight of the powder basecoat, and more preferably between 1.0 and 10.0 parts by weight of the flake additive per 100 parts by weight of the powder basecoat. It should be understood that the powder basecoat may be something other than a urethane powder basecoat, and that the flake additive may be some other flake additive than specifically mentioned herein.

The topcoat includes a clearcoat and preferably also includes a second basecoat. The second basecoat may be either a liquid basecoat or a powder basecoat as is well known in the art. If the second basecoat is a powder basecoat, then the second basecoat is a powder basecoat different than the powder basecoat comprising the flake additive described above. The clearcoat may be either a liquid clearcoat or a powder clearcoat as is well known in the art. It should be understood that the topcoat may only include the clearcoat, and that the second basecoat is optional.

The substrate is prepared prior to application of the powder primer onto the substrate. Preparation of the substrate includes cleaning the substrate with an iron phosphate wash. After cleaning the substrate, an electrocoat is applied to the substrate. The electrocoat is preferably applied by a process known as electrodeposition, in which the substrate is electrically charged and immersed in a bath of the electrocoat. The bath of the electrocoat includes an opposite electrical charge relative to the substrate. The particles in the bath of the electrocoat are attracted to the substrate, neutralized, and then cured. The preferred method includes making the substrate the cathode, in which the process is called cathodic electrocoating as is well known in the art. The electrocoat, which is deposited on to the substrate, is cured in an oven prior to application of the powder primer, as is well known in the art. After the electrocoat is cured, final preparation of the substrate may include sanding the electrocoat to reduce the average surface roughness (Rₐ) of the electrocoat.

The method further comprises applying the powder primer onto the substrate to form a powder primer layer. The powder primer layer is not cured, and is applied to the electrocoat of the prepared substrate by standard powder painting techniques as are well known in the art.

The method further comprises mixing the flake additive into the powder basecoat. It should be understood that the flake additive may be mixed into the powder basecoat before application onto the substrate, or during the application process. The method further comprises applying the powder basecoat onto the powder primer to form a powder basecoat layer. The powder basecoat, comprising the flake additive, is applied onto the powder primer dry-on dry, i.e., with no curing step or sinter bake between application of the powder primer and the powder basecoat. The flake additive prevents formation of surface irregularities in the powder primer layer and the powder basecoat layer, so that the surface irregularities are not transferred through to the finished painted surface, therefore providing a high quality appearance. The surface irregularities may include craters, dimples, etc. In other words, it should be understood that the surface irregularities include any type of “defect” that appears as an in-homogeneity in the visual appearance of the coating, which is finally formed upon the application and curing of all components. The surface irregularities arise from the interaction of the uncured powder primer and the powder basecoat. The powder basecoat is applied onto the substrate by standard powder painting techniques. Accordingly, both the powder primer and the powder basecoat are preferably applied in the same paint booth, as there are no curing, sintering, or dehydrating steps between application of the powder primer and the powder basecoat. However, it should be understood that the powder primer and the powder basecoat may be applied in separated paint booths if desired, so long as there is no oven or curing of the powder primer in-between.

The method further includes the step of simultaneously curing the powder primer and the powder basecoat. The curing temperature may be from 315° F. to 370° F. and the cure time may be from 12 to 55 minutes. In one preferred embodiment, the powder primer and the powder basecoat are preferably cured in an oven at 340° F. for between 12 and 55 minutes. It should be understood that the powder primer and the powder basecoat may be cured at other temperatures and times, and by other methods and still fall within the scope of the claims.

The method further comprises masking the substrate with a mask to define a first portion of the substrate and a second portion of the substrate. Accordingly, one of the first portion and the second portion is covered by the mask, with the other of the first portion and the second portion not covered by the mask for application of a second basecoat thereto as described below. It should be understood that the powder primer and the powder basecoat must be cured prior to masking the substrate. The mask typically includes paper taped to the substrate to prevent application of the second basecoat onto the portion covered by the paper. It should be understood that other materials may also be utilized in the masking step to prevent application of the second basecoat onto the masked, i.e., covered portion of the substrate, and still fall within the scope of the claims.

The method further comprises applying the topcoat onto the powder basecoat. As described above, the topcoat preferably includes a second basecoat and a clearcoat. However, it should be understood that the topcoat may include only the clearcoat. When the topcoat includes the second basecoat, the step of applying the topcoat is further defined as applying the second basecoat onto one of the first portion and the second portion of the substrate, i.e., the uncovered portion of the substrate. For example, a bottom portion of a door panel may be masked, defining an upper uncovered portion and a lower covered portion. The second basecoat is applied to the upper uncovered portion, with the masking preventing application of the second basecoat onto the lower covered portion. Accordingly, the door panel includes the powder basecoat on the lower portion and the second basecoat on the upper portion. It should be understood that if the second basecoat is a liquid, then the liquid basecoat is applied by standard liquid painting techniques as are well known in the art. Likewise, if the second basecoat is a powder, then the second powder basecoat is applied by standard powder painting techniques as are well known in the art. If the topcoat does not include the second basecoat, then the step of applying the topcoat is further defined as applying the clearcoat onto the powder basecoat having the flake additive.

The method further comprises de-masking the substrate to expose the one of the first portion and the second portion covered by the mask. Once the second basecoat has been applied to the uncovered portion of the substrate, the masking is removed, thereby exposing the covered portion of the substrate.

When the topcoat includes a clearcoat, then the step of applying the topcoat is further defined as applying the clearcoat onto the powder basecoat and the second basecoat over both the first portion and the second portion of the substrate. It should be understood that the clearcoat is applied after de-masking the substrate.

The method further comprises curing the topcoat by application of heat. As described above, the topcoat preferably includes both the second basecoat and the clearcoat, in which case the step of curing the topcoat is further defined as simultaneously curing the second basecoat and the clearcoat by application of heat. The topcoat may be cured at temperatures ranging from about 245° F. to about 285° F., for between about 10 and 50 minutes. In one preferred embodiment, the topcoat is preferably cured in an oven at a temperature of about 265° F. for between 10 and 50 minutes. It should be understood that the topcoat may be cured at other temperatures and times and by other methods not specifically described herein and still fall within the scope of the claims.

The foregoing invention has been described in accordance with the relevant legal standards, thus, the description is exemplary rather than limiting in nature. Variations and modifications to the disclosed embodiments may become apparent to those skilled in the art and do come within the scope of the invention. Accordingly, the scope of legal protection afforded this invention can only be determined by studying the following claims.

What is claimed is:

1. A method of painting a substrate with a powder primer, a powder basecoat, and a topcoat, said method comprising the steps of:
applying the powder primer onto the substrate to form a powder primer layer;
applying the powder basecoat comprising a flake additive onto the powder primer to form a powder basecoat layer;
simultaneously curing the powder primer and the powder basecoat wherein the flake additive prevents formation of surface irregularities in the powder primer layer and the powder basecoat layer;
applying the topcoat onto the powder basecoat; and
curing the topcoat by application of heat.

2. A method as set forth in claim 1 wherein the flake additive comprises at least one of a mica flake and a metal flake.

3. A method as set forth in claim 1 further comprising the step of mixing the flake additive into the powder basecoat.

4. A method as set forth in claim 3 wherein the step of mixing the flake additive into the powder basecoat is further defined as mixing the flake additive into the powder basecoat to form a mixture comprising between 0.1 and 10.0 parts by weight of the flake additive per 100 parts by weight of the powder basecoat.

5. A method as set forth in claim 1 further comprising the step of masking the substrate with a mask to define a first portion of the substrate and a second portion of the substrate with one of the first portion and the second portion covered by the mask.

6. A method as set forth in claim 5 wherein the topcoat includes a second basecoat and wherein the step of applying the topcoat is further defined as applying the second basecoat onto one of the first portion and the second portion of the substrate.

7. A method as set forth in claim 6 wherein the second basecoat is a liquid basecoat.

8. A method as set forth in claim 6 wherein the second basecoat is a powder basecoat different than the powder basecoat comprising the flake additive.

9. A method as set forth in claim 6 further comprising the step of de-masking the substrate to expose the one of the first portion and the second portion covered by the mask.

10. A method as set forth in claim 6 wherein the topcoat includes a clearcoat and wherein the step of applying the topcoat is further defined as applying the clearcoat onto the powder basecoat and the second basecoat.

11. A method as set forth in claim 10 wherein the clearcoat is a liquid clearcoat.

12. A method as set forth in claim 10 wherein the clearcoat is a powder clearcoat.

13. A method as set forth in claim 10 wherein the step of curing the topcoat is further defines as simultaneously curing the second basecoat and the clearcoat by application of heat.

14. A method as set forth in claim 2 wherein the powder basecoat is a urethane powder basecoat.

15. A method as set forth in claim 2 wherein the powder primer is a low density powder primer.
